(19) United States
(12) Patent Application Publication
(10) Pub. No.: US 2006/0172744 A1
(43) Pub. Date: Aug. 3, 2006

(54) Method and system for subscriber integrity in a mobile communications system

(76) Inventors: Robert Tornkvist, Karishamn (SE); Johnny Karisson, Nattraby (SE); Jorgen Johansson, Vassmolosa (SE)

Correspondence Address: ERICSSON INC., 6300 LEGACY DRIVE, M/S EVR C11, PLANO, TX, 75024, US

(21) Appl. No.: 10/595,015

(22) PCT Filed: Jun. 27, 2003
(86) PCT No.: PCT/SE03/01123

§ 371 Date: Dec. 16, 2005

(51) Int. Cl. H04Q 7/20

(52) U.S. Cl. 455/456.1

(57) ABSTRACT

A system and method for protecting the integrity of subscribers in a process of positioning a mobile terminal (2b) via a location based service client (5), in relation to the client (5), in a communications system. A gateway mobile location centre (4) is adapted to: receive a request for an alias identity for an entity (1a) initiating to be positioned; assign an alias identity for the entity (1a) and the subscriber (2a); store the alias identities for the entity (1a) and the subscriber (2a) in association with the subscriber numbers; receive a positioning request from the client (5) for the subscriber (2a), wherein the request includes the alias identity for the subscriber (2a); look up the subscriber number matching the alias identity; perform a positioning request for the mobile terminal in a n associated network (3); and send a response including location information received from the network (3) and the alias identity to the client (5)

### TECHNICAL FIELD OF THE INVENTION

The invention relates to the field of mobile telephony and more particularly to the field of protecting the integrity of subscribers, in relation to a location based service client used in a process of positioning a mobile terminal.

### BACKGROUND OF THE INVENTION

A system for mobile positioning enables a mobile network operator to provide location-based services to its customers. Positioning is the process of geographically locating mobile stations (MS) in a Public Land Mobile Network (PLMN) by collecting and analyzing needed information. The position is calculated and reported to an application for further usage. Location information is an important enabler for many of the new services in the third generation mobile networks. In some countries there are also legal requirements on providing location information when for example an emergency call is made from a mobile station.

The knowledge of the location of a mobile station or entity opens up a new set of applications and enhance existing ones. A number of different applications in different fields, such as governmental, operators or commercial applications are and will be provided.

Each target group has its own demands and needs concerning location based services. For example, governmental use is applicable for public welfare such as emergency calls and infrastructure planning.

Depending on the type of application it can be run either by an operator or a service provider. The operator is able to offer service providers access to location information, and the operator can also run its own applications. Existing services can be greatly enhanced and new services can be developed, with the knowledge of the geographical position of a mobile entity.

A location based services client (LCS-C) is often a service provider outside the control of the mobile network operator. Since a subscriber usually has a looser relationship with the service provider than with its mobile network operator the issue of trust and confidence of what its position can be used for is an obstacle for some location based services. The lack of user integrity in prior art systems is a problem, both with respect to the party utilizing the LCS for positioning and the party being positioned.

Another problem is that in many countries it is prohibited—due to legislation and regulation—to distribute position data of a user without the user's consent.

No prior art system or method solves this problem in the current PLMNs. There are however proposals, all of which depend on new network features or protocols.

WO-01/99463 discloses a method and system for integrity positioning of a mobile station. A subscriber in a communication network connects to a homepage or portal of a service provider supplying positioning services in an open computer network such as the Internet. The subscriber specifies the subscriber number of his mobile station in order to obtain the positioning service. Hence, the subscriber is no longer anonymous with respect to the service provider.

WO-02/49380 discloses mobile positioning using encrypted ID. The user connects to the positioning service provider via the Internet. Thus, the anonymity is at the same level as on the Internet. Also, it is limited to mobile internet access—and not usable for voice/sms access to the service.

The first time the user accesses a specific positioning service provider, he is directed back to his operator and is required to register himself by entering his phone number. The registration is authenticated via an SMS-code-return procedure. The operator creates an own alias which is sent to the positioning service provider. The user's real identity never leaves the operator domain.

A drawback of the proposed solution is that it requires implementation in the LCS Client and the SMS-C. A new node and an Alias Server, for handling the aliases, are also required and new protocols are needed between the nodes.

Further, WO-0249380 only covers the case when a user utilizes a positioning service for positioning himself. Additional administration is also required since there are three lists that contains more or less the user identity, but with different forms of encryption (aliases).

Common drawbacks for these prior art systems are that the subscriber has to access the service via the Internet. This means that the user access a service providers homepage on the Internet and initiates the service. Thus, no triggering/access of the service is provided from the telecom domain, for example SMS/MMS or voice.

Moreover, the prior art only concerns the anonymity of the requesting subscriber. It does not take into account the anonymity of one or several requested parties, who may be different from the requesting party. Further, the LCS Client and/or the user terminal is required to participate in the anonymity method.

### SUMMARY OF THE PRESENT INVENTION

The objective of the invention is to provide a method for protecting the integrity of subscribers in relation to a location based service client used in a process of positioning a mobile terminal, with respect to both the subscriber requesting a positioning of the mobile terminal and a subscriber of the mobile terminal to be positioned.

In order to achieve said object the invention provides a method characterised by the steps of:

assigning an alias identity for an entity initiating a positioning request and/or for a subscriber associated with said mobile terminal to be positioned,

storing said alias identity for said entity and/or for the subscriber in association with the subscriber number of said entity and the subscriber, respectively,

receiving a positioning request from said location based service client for said subscriber, said request including said alias identity for said subscriber,

looking up the number matching said alias identity for said subscriber,

performing a positioning request for said mobile terminal in an associated network,

sending a response including location information received from said network and said alias identity to said location based service client.

The invention also provides a system comprising means for working the method, which is characterised by a gateway mobile location centre adapted to:

receive a request for an alias identity for an entity initiating a positioning request and/or for a subscriber associated with said mobile terminal to be positioned,

assign an alias identity for said entity and/or for said subscriber,

store said alias identity for said entity and/or for said subscriber in association with the subscriber number of said entity and said subscriber, respectively,

receive a positioning request from said location based service client for said subscriber, said request including said alias identity for said subscriber,

look up the subscriber number matching said alias identity for said subscriber,

perform a positioning request for said mobile terminal in an associated network,

send a response including location information received from said network and said alias identity to said location based service client.

An advantage of the invention is that the method is transparent to the LCS Client so that no business relationship or technical relationship concerning the anonymity is required between the LCS client and the network operator.

### BRIEF DESCRIPTION OF THE DRAWINGS

For a better understanding of the present invention and in order to show how the same may be carried into effect reference will now be made to the accompanying drawings, in which:

FIG 1A illustrates an example of a communication network configuration including a first embodiment of the system according to the invention,

FIGS. 1B and 1C is a flowchart of a first embodiment of the method according to the invention,

FIG. 2A illustrates another example of a communication network configuration including a second embodiment of the system according to the invention, and

FIG. 2B is a flowchart of a second embodiment of the method according to the invention.

### DETAILED DESCRIPTION OF THE INVENTION

The present invention provide a positioning method and system wherein a location based service client (LCS-C), which is outside the control of a mobile network operator, knows an identifier for a first user A with a mobile radio terminal and/or a second user B with a second mobile radio terminal, so that the service can take place. The LCS-Client is, however, unable to determine the real identity of the user (A and/or B), for example the MSISDN number.

Referring now to the drawings, wherein like or similar elements are designated with identical reference numerals, there are block diagrams and flowcharts including signalling depicting the method according to the invention. The purpose of these diagrams are to illustrate the features of the invention and the basic principles of operation of embodiments thereof. It should also be emphasised that the terms “comprises” and “comprising” when used in this specification is taken to specify the presence of stated features, integers, steps or components but does not preclude the presence or addition of one or more other features, integers, steps, components or groups thereof.

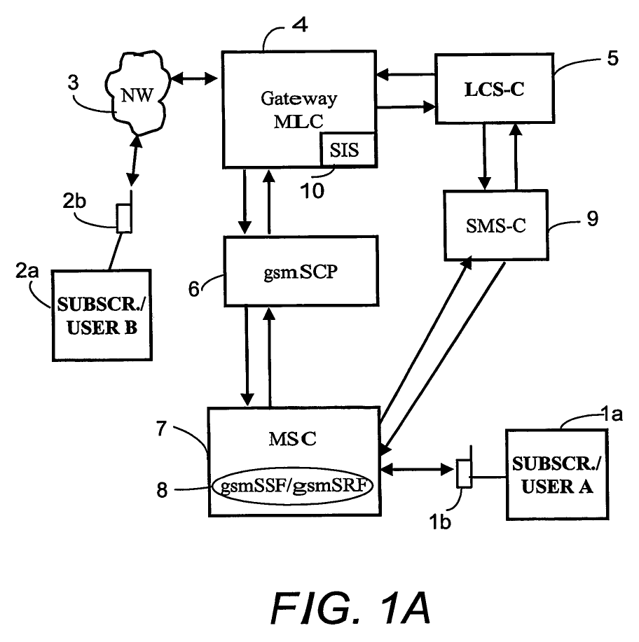

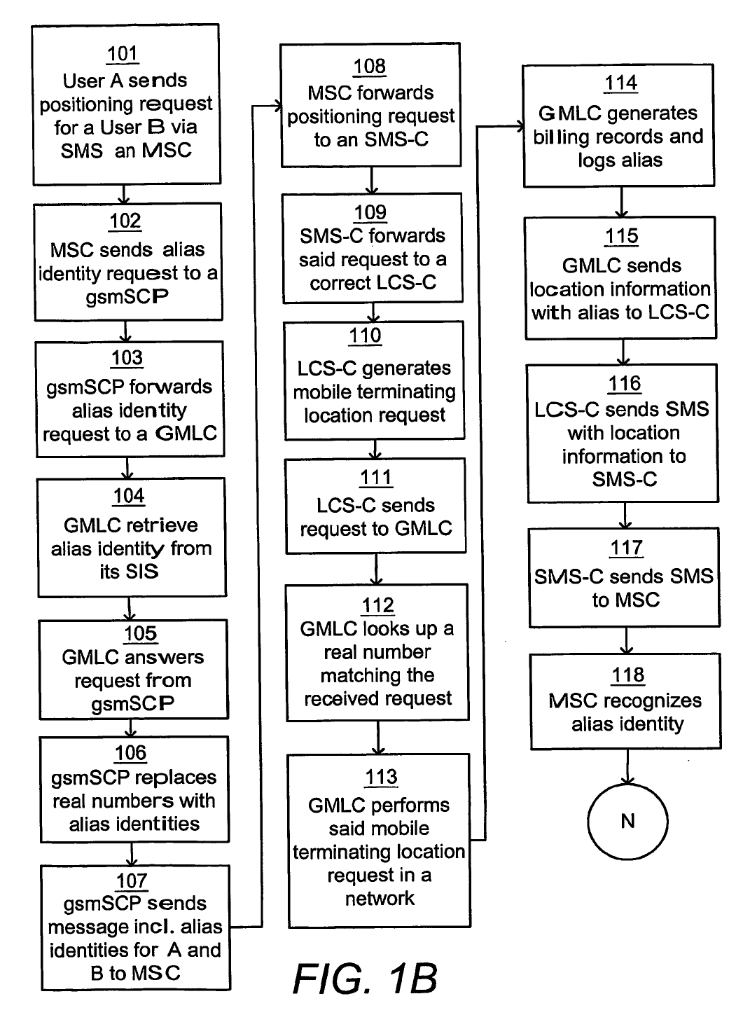

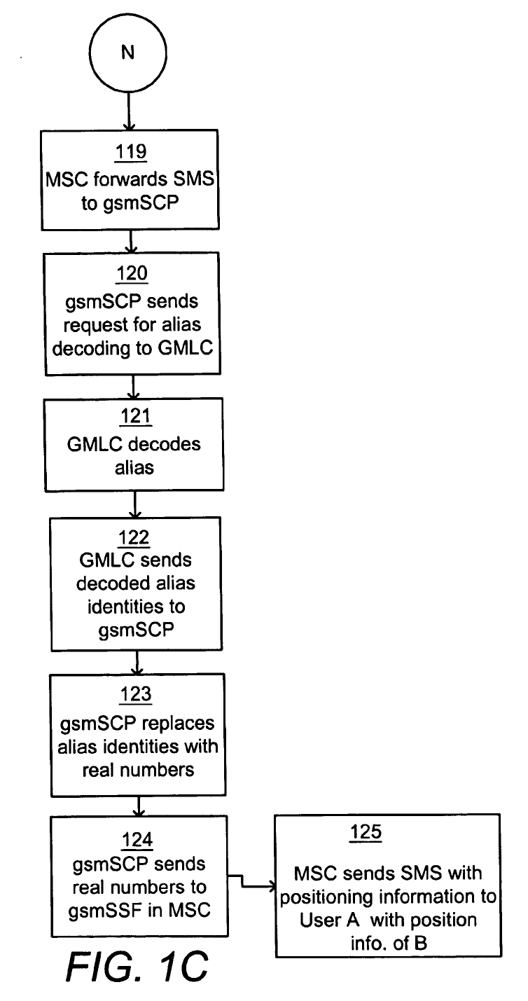

FIG. 1A illustrates an example of a communication network configuration including a first embodiment of the system according to the invention, adapted to protect the integrity of a first subscriber 1a and/or a second subscriber 2a, wherein the first subscriber la requests the position of a second subscriber 2a located in a network 3 when the subscriber 1a is utilizing a location based service (LCS). In this exemplary embodiment the first subscriber 1a has a first portable radio communication equipment 1b and the second subscriber 2a has a second portable radio communication equipment 2b.

The term portable radio communication equipment, which herein after is referred to as a mobile radio terminal or mobile terminal includes but is not limited to all equipment such as mobile telephones, pagers, communicators, electronic organizers, smart phones or the like.

Although the first subscriber la requests for the position of the second subscriber 2a it is the position of the mobile radio terminal 2b that is determined. It is not necessary that neither the first nor the second mobile radio terminal 1a or 1b is currently used by the subscriber, but by another user (A or B). In a case when the requesting user A is different from the requested user B, the request can be made from a fixed equipment.

The system according to the invention comprises a Gateway Mobile Location Centre (GMLC) 4. In one embodiment of the invention, the GMLC 4 is a system that comprises at least a computer processor or other processing component and a data store operatively connected to the processing component.

The GMLC 4 is the link between the PLN (Public Land Mobile Network) 3 and location services clients (LCS-C) 5. Generally, the GMLC receives positioning requests, performs the necessary authentication, initiates the positioning in the PLMN, and sends back the positioning information to the requesting application.

The GMLC and a Serving Mobile Location Centre (SMLC) (not shown), or GMLC alone,—which collects position information form the communications network and calculates the co-ordinates to be used by the application—allows authorized applications, provided by the operator or third parties, to locate a mobile radio terminal using a variety of methods.

An IN service (gsmSCP) together with the GMLC are adapted to implement and support anonymous arid pseudonymous identities according to the invention. Hence, no additional network node is required.

The GMLC 4 is the GSM/UMTS PLMN node to be accessed by an external location services client (LCS-C) 5 when it requests the location of a certain mobile station. The GMLC 4 offers interfaces, http in this embodiment, through which the LCS-C 5 and the GMLC 4 communicates, for example over an IP network, i.e. the Internet. The communication includes positioning requests from the LCS-C 5 and positioning answers from the GMLC 4. Moreover, the GMLC 4 performs, among other things, an authorization check on the request.

There are a number of different scenarios where anonymity of the user's identity is required. The different scenarios require different handling of the anonymity. The embodiments disclosed herein relates to the telecom domain access (voice/sms/mms) and utilizes IN technology but is not limited thereto. The method as such does not require IN but is the most efficient solution in terms of implementation cost.

The GMLC 4 also interfaces a gsmSCP (gs-m Service Control Point) 6. In one embodiment the CS1+protocol is used to interface the gsmSCP. This protocol is developed by the applicant and is an extension to ETSI Capability Set 1 (CS1). The invention is however not limited thereto and, for example, CAMEL in release 5 of 3gpp is applicable as well.

Basic operations for the communication between GMLC 4 and gsmSCP 6 are needed to handle aliases and outlined in the table below.

| Request | Response | Comment |
|---|---|---|
| Get_Alias ( ) | Ack Alias ( ) | To create or get |
| Requested msisdn, | aliasID for | an anonym or |
| | requested | pseudonym alias. |
| Requester msisdn, | msisdn, | The new aliasID |
| | aliasID for | is sent back in |
| ClientId | requester msisdn | an ack. |
| Get Identity ( ) | Ack_Identity ( ) | To get the true |
| | | identity, e.g. |
| Requested_alias | Requested trueID | MSI SDN for an |
| Requester_alias | Requester trueID | alias. The true |
| | | identity is sent |
| | | back in the ack. |

up in an MSC (Mobile Service Switching Centre) 7. When an SMS (Short Message Service) arrives at these numbers a gsmSSF (gsm Service Switching Function)/gsmSRF (gsm Service Resource Function) 8 of the MSC 7 is triggered and routes the positioning request to the gsmSCP 8. The gsmSCP 6 extracts the requested and requesting number and forwards these to the GMLC 4. An SIS module 10 in the GMLC 4 is adapted to assign alias identities for the requesting and/or requested user and the flow is reversed. The GMLC assign alias Ids and the flow is reversed.

When assigning the IDs there is a distinction between anonymous and pseudonymous IDs so that it can be determined which one is what.

The GMLC keeps track of which alias that belongs to which MSID. The mapping between the true identity, MSID, and alias ID are stored persistent in the GMLC as long as necessary. The durability depends on if it is an anonymous or pseudonymous alias and for how long time it is necessary to keep it stored to sustain the services of operation, billing etc.

An anonymous id and/or pseudonymous id are stored in the GMLC for basic ID substitution services and are assigned for requesting and requested subscriber.

The IDs are preferably in a format that can not be mistaken for a true MSID, e.g. an MSISDN number, and it shall preferably not be reversible to its true identity by means of knowing a certain algorithm.

With further reference to FIG 1A, the SMS-C 9 is provided for SMS communication between the LCS-C 5 and the MSC 7.

Although, only one or two instances of each entity 1-10 are shown on the drawings, this is only for the purpose of illustration. It is however obvious for the skilled man that the system can comprise a number, not necessary the same number, of entities 1-10 within the scope of the invention. For example, in an alternative embodiment of the system configuration at least one GMLC 4 among a number of GMLCs is adapted to handle connections from multiple LCS-C clients 5 simultaneously.

In a first embodiment of the method according to the invention illustrated by the flowchart in FIGS. 1B and 1C, an SMS request is sent from User A to a dedicated phone number for positioning (office based IN triggering) in step 101. The SMS contains the number of a User B that the User A intends to locate. This number is the User B's real number (but it could be User B's alias as well). In an alternative embodiment User A has to send the User B number separately instead of including it in the SMS. A request is sent to the gsmSCP 6 in step 102 to get an anonymity number or alias identity for either User A, User B, or both. In this exemplary embodiment the User A and User B are different users and thus alias identities are created. In an alternative embodiment aliases are created also in the case where a single user wants to position himself. The gsmSCP 6 forwards this request in step 103 to an SIS (Subscriber Identity Server) 10 in the GMLC 4 to retrieve the actual alias identity in step 104. The SIS 10 is located in the GMLC 4 in this embodiment.

The SIS 10 answers the request with an alias identity in step 105 and the gsmSCP 6 replaces the real numbers of User A and User B with the alias identities in step 106, and sends a message including the alias back to the gsmSSF 8 in the MSC 7 in step 107.

The MSC 7 forwards the positioning request to the SMS-C 9 with the alias identity in step 108. In the next step 109 the SMS-C 9 forwards the request to the correct LCS-C 5, i.e the LCS that provides the current serivce. The LCS-C generates positioning request in step 110 and sends it to the GMLC 4 in step 111. The GMLC 4 looks up the number matching the alias identity in step 112 and a mobile terminating positioning request for User B is performed in the network 3, in step 113.

The GMLC 4 generates billing records as well as logs alias used for each user in step 114.

A response message with Location information is sent to the LCS-C 5 from the GMLC 4, using the alias identity, in step 115. The LCS-C 5 sends a new SMS to the SMS-C 9 including the location information to the alias identity of User A in step 116. The SMS-C 9 sends the SMS to the MSC 7, with the alias identity in step 117. The MSC 7 recognizes the alias identity in step 118 and forwards the SMS to the gsmSCP 6 in step 119. A request is sent from the gsmSCP 6 to the GMLC 4 in step 120 for decoding the alias identities in step 121. The decoded alias identities is returned to the gsmSCP 6 in step 122.

After this step the alias identity could be reused in subsequent positioning processes for the particular users.

The gsmSCP 6 replaces the alias identities with the real numbers in step 123 and sends the SMS to the gsmSSF 8 in step 124. Then, the SMS is sent to the User A in step 125. The user can for example read the position on the display of its mobile radio terminal or use the received position information in an optional way.

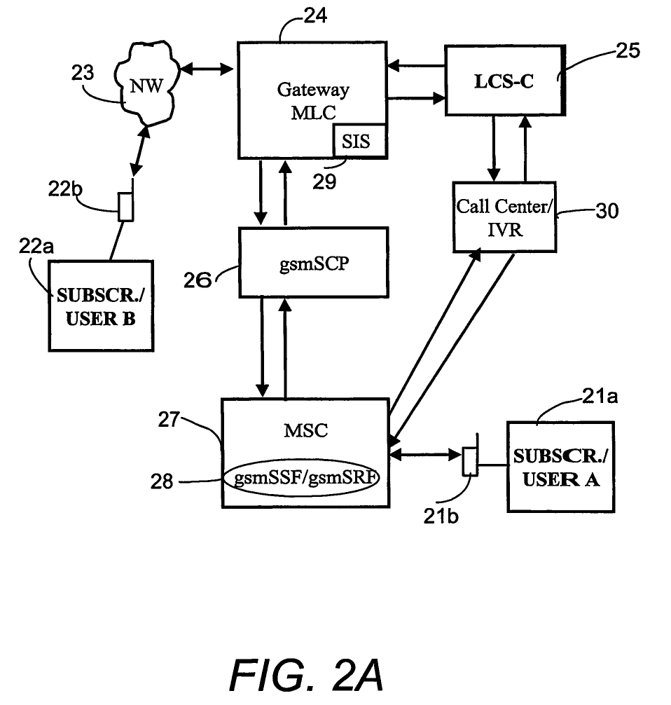

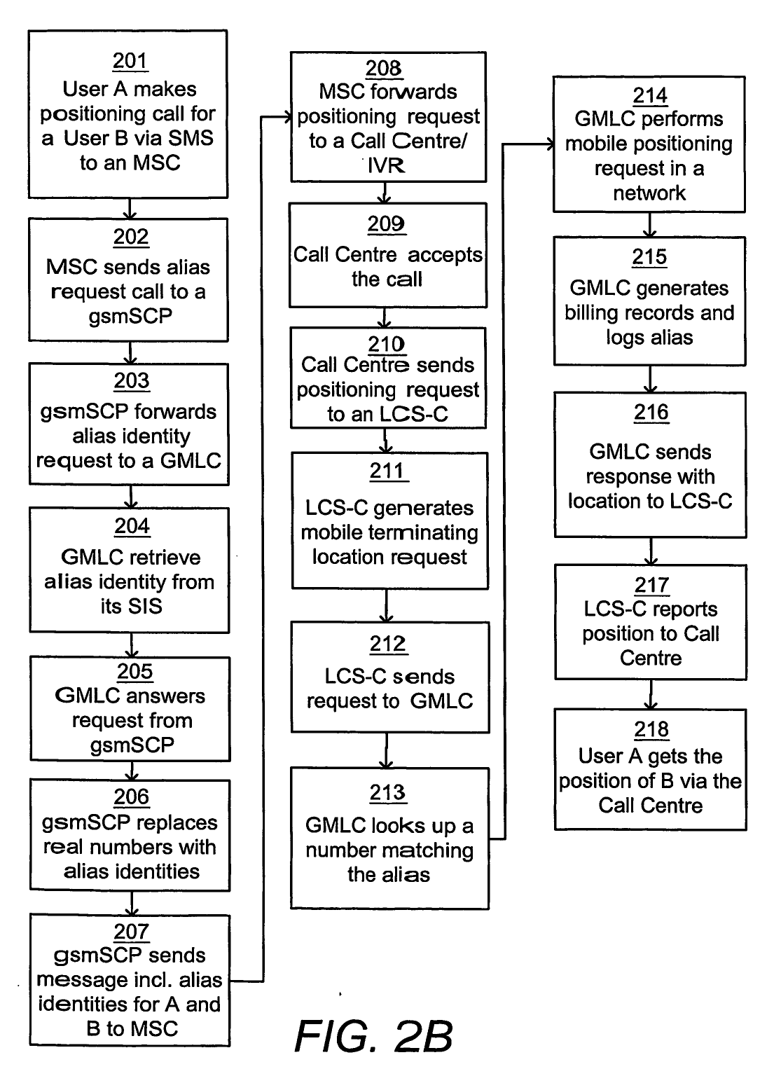

FIG. 2A illustrates another example of a communication network configuration including a second embodiment of the system according to the invention, which provides the method of protecting the integrity of a first subscriber 21a or User A requesting the position of a second subscriber 22a or User B located in a network 23 when utilizing location based services (LCS) via an LCS-client. User A has a first portable radio terminal 21b and User B has a second portable radio terminal 22b.

As an alternative embodiment a positioning request needs not to be initiated by a subscriber, but can also be initiated by another entity, for example a service on the Internet or by the network itself (so called network induced location request).

The system configuration comprises a Gateway Mobile Location Centre (GMLC) 24. In one embodiment of the invention, the GMLC 24 is a system that comprises at least a computer processor or other processing component and a data store operatively connected to the processing component.

The GMLC 24 is the GSM/UMTS PLMN (Public Land Mobile Network) node to be accessed by an external location service (LCS-C) client 25 when it requests the location of a certain mobile station. The GMLC 24 offers interfaces, through which the LCS client 25 and the GMLC 24 communicates, for example over an IP network, i.e. the Internet. The communication includes positioning requests from the LCS-C 25 and positioning answers from the GMLC 24. Moreover, the GMLC 24 performs, among other things, an authorization check on the request.

The GMLC 24 is adapted to assign alias identities to both requesting and requested parties. Further, the GMLC 24 has an interface to a gsmSCP 26.

IN services is used and dedicated number(s) are set up in an MSC 27 and when a voice call arrives at these numbers a gsmSSF/gsmSRF 28 is triggered and routes the positioning request to the gsmSCP 26. The gsmSCP 26 is adapted to extract the requested and requesting number and forward these to the GMLC 24. An SIS module 29 in the GMLC 24 is adapted to assign alias identities for the requesting and/or requested user and the flow is reversed.

User A makes a positioning call to a dedicated phone number in step 201. This number is the number of user B with a prefix which indicate to the MSC that it is a positioning request so that the call is forwarded. The call is then forwarded to the gsmSCP 26 in step 202 for retrieving the alias identity. The gsmSCP 26 requests alias identities for User A and/or User B in step 203. Optionally a dedicated number without prefix could be used and user A gets a voice prompt to input the number for the user B that User A wants to position. The GMLC 24 retrieves the alias identity or identities in step 204 and returns it or them to the gsmSCP 26 in step 205.

The gsmSCP 26 replaces the User A and/or user B number with the alias identity or identities in step 206 and sends a message including said identity or identities to the gsmSSF 28 of the MSC 27 in step 207.

The request is diverted by the MSC 27 to a Call Center/IVR 30 in step 208. After the call has been accepted by the Call Center in step 209 a positioning request is sent to the LCS Client 25 in step 210. The LCS Client 25 generates a location request in step 211 and sends it towards the GMLC 24 in step 212.

In a next step 213 the GMLC looks up the number matching the alias identity.

A mobile terminating positioning request is performed in the network, for User B in a next step 214.

The GMLC can generate billing records as well as logging which alias was used for which user in step 215.

A response with the location is sent to the LCS Client 25 from the GMLC 24, using the alias identity, in step 216. After this step the alias identity could be reused in subsequent positioning requests.

The position is reported to the Call Center/IVR 30 in step 217 and the User A gets the position information from a telephone operator or IVR on existing voice route via the MSC 27 in step 218.

An anonymous identity is only valid for one request, and therefore the E.164 numbers used for aliases can be reused. A pseudonymous identity can be used by the same subscriber for many subsequent requests. The true identity of the subscriber is only known by the operator for both types of request.

For the SMS and Voice scenarios the anonymity service in the GMLC is adapted to receive requests from a gsmSCP. This request contains the identifications for requested and/or requesting user. The anonymity service assigns alias ID(s) and sends the result back. This works in an inter-GMLC roaming and the 3GPP specified roaming situation.

The method and system of protecting the integrity of subscribers utilizing location based services (LCS) via an LCS-client used in a process of positioning a mobile terminal, with respect to both the subscriber requesting a positioning of the mobile terminal and a subscriber of the mobile terminal to be positioned, provides anonymity or pseudonymity by replacement of identities with alias identities according to the invention. Anonymity and pseudonymity means that requesting and/or requested parties (S) are able to use positioning services or be positioned without revealing their true identity to the LCS-Client involved in the positioning process. When alias identities are used, the method is able to assign alias identities for requesting and/or requested parties.

Although the invention has been described in conjunction with SMS and voice communication it is equally applicable for MMS. The two example embodiments of the system and method according to the invention have been described separately for illustration purposes. However, in a third embodiment the two systems are integrated forming a system adapted to, but is not limited to, perform the methods of at least the first and second embodiment of the method according to the invention. In this third embodiment the GMLC, gsmSCP, and the MSC are adapted to handle at least SMS and voice communications according to the above described first and second embodiments of the method.

1. A system for protecting the integrity of subscribers when positioning a mobile terminal via a location based service client in relation to said location based service client
a node adapted to:
receive a request for an alias identity from an entity initiating a positioning request for a subscriber associated with said mobile terminal to be positioned,
assign an alias identity for said entity and/or for said subscriber,
store said alias identity for said entity and/or said subscriber in association with an identity of said entity and said subscriber respectively,
receive a positioning request from said location based service client for said subscriber, said request including said alias identity for said subscriber,
look up the subscriber number matching said alias identity for said subscriber,
perform a positioning request for said mobile terminal in an associated network, and
send a response including location information received from said network and said alias identity to said location based service client.

2. The system according to claim 1, further comprising
a service control point adapted to:
receive a request for an alias identity for said entity and/or said subscriber from a mobile switching centre,
forward said request for an alias identity to said node to retrieve said alias identity for said entity and said subscriber, and
send a response including said alias identity for said entity and said subscriber to said mobile switching center.

3. The system according to claim 2, wherein said mobile switching centre is adapted to forward the positioning request from said entity with said alias identity for said entity and said subscriber to said location based service client.

4. The system according to claim 3, wherein said positioning request from said entity is an SMS message and that said mobile switching centre is adapted to forward said positioning request from said entity to said location based service client via an SMS-Centre.

5. The system according to claim 3, wherein said positioning request from said entity is a voice call and that said mobile switching centre is adapted to forward said positioning request from said entity to said location based service client via a call centre or IVR.

6. The system according to claim 1, wherein said entity is a subscriber.

7. The system according to claim 1, wherein said alias identity is a E.164 number.

8. A method for protecting the integrity of subscribers when positioning a mobile terminal via a location based service client in relation to said location based service client, in a communications system, comprising the steps of:
assigning an alias identity for an entity initiating a positioning request or for a subscriber associated with said mobile terminal to be positioned,
storing said alias identity for said entity or for said subscriber in association with a subscriber number of said entity and said subscriber, respectively,
receiving a positioning request from said location based service client for said subscriber, said request including said alias identity for said subscriber,
looking up the number matching said alias identity for said subscriber,
performing a positioning request for said mobile terminal in an associated network, and
sending a response including location information received from said network and said alias identity to said location based service client.

9. The method according to claim 8, further comprising the steps of:
at a service control point, receiving a request for an alias identity for said entity and said subscriber W from a mobile switching centre,
forwarding said request for an alias identity to said gateway mobile location centre to retrieve said alias identity for said entity and said subscriber, and
sending a response including said alias identity for said entity and said subscriber to said mobile switching centre.

10. The method according to claim 9, further comprising the step of:
from said mobile switching centre, forwarding the positioning request from said entity with said alias identity for said entity and said subscriber to said location based service client.

11. The method according to claim 10, wherein said positioning request from said entity is an SMS message and that said positioning request from said entity is forwarded to said location based service client via a an SMS-Centre.

12. The method according to claim 10, wherein said positioning request from said entity is a voice call and that said positioning request from said entity is forwarded to said location based service client via a call centre or IVR.

13. The method according to claim 8, wherein said entity is a subscriber.

14. The method according to claim 8 wherein said alias identity is a E.164 number.

15-17. (canceled)
